(19) United States
(12) Patent Application Publication
(10) Pub. No.: US 2026/0014401 A1
(43) Pub. Date: Jan. 15, 2026

(54) SYSTEM AND METHOD FOR SMART CITY FIREFIGHTING AND AUTOMATIC EXTINGUISHMENT BASED ON INTERNET OF THINGS LARGE MODEL

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/337,883

(22) Filed: Sep. 23, 2025

(30) Foreign Application Priority Data
Aug. 25, 2025 (CN) 202511189859.6

(51) Int. Cl. A62C 37/44; A62C 3/02

(52) U.S. Cl. CPC A62C 37/44; A62C 3/0271; A62C 3/0292

(57) ABSTRACT

Disclosed is a system and method for smart city firefighting and automatic extinguishment based on an Internet of Things large model. The system includes an emergency monitoring and management platform configured to: obtain emergency monitoring data; determine emergency monitoring data for a protection region based on the emergency monitoring data and regional characteristic data; determine, based on the emergency protection data, an emergency control parameter, the emergency control parameter including a protection activation condition, an extinguishment target, and a protection-extinguishment parameter; send, based on the emergency control parameter, an extinguishment control signal to an extinguishment device installed in the protection region through an emergency monitoring sensing network platform to drive the extinguishment device to perform emergency extinguishment by the emergency control parameter.

### CROSS-REFERENCE TO RELATED APPLICATIONS

This application claims priority to Chinese Patent Application No. 202511189859.6, filed on Aug. 25, 2025, the entire contents of which are hereby incorporated by reference.

### TECHNICAL FIELD

The present disclosure relates to the field of urban firefighting technology, and in particular, to a system and method for smart city firefighting and automatic extinguishment based on an Internet of Things (IoT) large model.

### BACKGROUND

With a high concentration of urban populations and a continuous rise in building density, urban fires are often characterized by rapid spread, strong destructiveness, and numerous secondary hazards. For example, in a large commercial complex, if a fire source is not accurately located, it may easily lead to a waste of resources on one hand, and a rapid spread of the fire to adjacent regions on the other hand. In a densely populated region, delays in the response to manual monitoring may lead to a rapid deterioration of a disaster. As a result, a response efficiency and an accuracy of urban fire safety management face serious challenges.

Therefore, it is desired to provide a system and method for smart city firefighting and automatic extinguishment based on an IoT large model to improve a response speed and a resource utilization efficiency of the disaster, and thus enhance a firefighting efficiency and reduce disaster losses.

### SUMMARY

One or more embodiments of the present disclosure provide a method for smart city firefighting and automatic extinguishment based on an IoT large model. The method includes: obtaining emergency monitoring data; determining emergency protection data for a protection region based on the emergency monitoring data and regional characteristic data; determining, based on the emergency protection data, an emergency control parameter, the emergency control parameter including a protection activation condition, an extinguishment target, and a protection-extinguishment parameter; sending, based on the emergency control parameter, an extinguishment control signal to an extinguishment device installed in the protection region through an emergency monitoring sensing network platform to drive the extinguishment device to perform emergency extinguishment by the emergency control parameter, including: controlling rotation of a spray head of the extinguishment device to orient toward the extinguishment target; and in response to satisfying the protection activation condition, activating the extinguishment device to perform extinguishment based on the protection-extinguishment parameter with a preset coverage area and a preset spray flow rate.

One or more embodiments of the present disclosure provide a system for smart city firefighting and automatic extinguishment based on an IoT large model. The system includes an emergency monitoring and management platform, the emergency monitoring and management platform being configured to perform the method for smart city firefighting and automatic extinguishment based on an IoT large model as described in any of the embodiments of the present disclosure.

One or more embodiments of the present disclosure provide a non-transitory computer readable storage medium. The computer-readable storage medium stores computer instructions, and when a processor executes the computer instructions in the storage medium, the processor implements the method for smart city firefighting and automatic extinguishment based on an IoT large model as described in any of the embodiments of the present disclosure.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, where like reference numerals represent similar structures throughout the several views of the drawings, and wherein:

FIG. 1 is a schematic diagram illustrating a platform structure of a system for smart city firefighting and automatic extinguishment based on an IoT large model according to some embodiments of the present disclosure;

FIG. 2 is an exemplary flowchart illustrating a method for smart city firefighting and automatic extinguishment based on an IoT large model according to some embodiments of the present disclosure;

FIG. 3 is an exemplary schematic diagram illustrating a risk estimation model according to some embodiments of the present disclosure; and

FIG. 4 is an exemplary schematic diagram illustrating an effect determination model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the magnetic resonance imaging method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

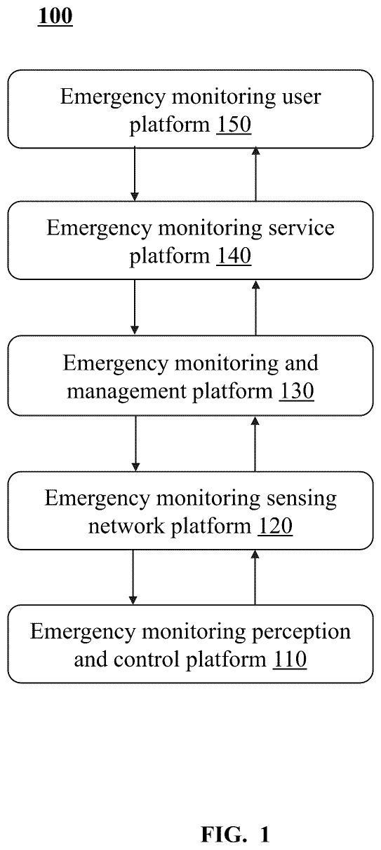

FIG. 1 is a schematic diagram illustrating a platform structure of a system for smart city firefighting and automatic extinguishment based on an IoT large model according to some embodiments of the present disclosure.

In some embodiments, as shown in FIG. 1, the system 100 for smart city firefighting and automatic extinguishment based on an IoT large model may include an emergency monitoring perception and control platform 110, an emergency monitoring sensing network platform 120, an emergency monitoring and management platform 130, an emergency monitoring service platform 140, and an emergency monitoring user platform 150.

The emergency monitoring perception and control platform 110 refers to an object platform that generates sensing information and executes control information. In some embodiments, the emergency monitoring perception and control platform may include a monitoring device and an extinguishment device.

The monitoring device refers to a device that monitors emergency monitoring data and regional characteristic data for a protection region. In some embodiments, the monitoring device may be configured as an environmental sensor, an image sensor, a radio frequency identification (RFID) tag, etc.

The environmental sensor may include a temperature sensor, a smoke sensor, a humidity sensor, a gas sensor, etc.

The image sensor may include a camera, an infrared camera device, or the like. The image sensor may monitor open flame operations and temperature distribution data.

The RFID tag is used to identify a status of a firefighting device (e.g., the extinguishment device).

The extinguishment device refers to a device that performs an extinguishment operation, such as a fire extinguisher, a sprinkler head, or the like. The extinguishment device may include a plurality of extinguishment devices pre-installed inside a building, around a building, along a roadway, on a streetlight, and/or on a building facade.

The emergency monitoring sensing network platform 120 refers to a functional platform that manages sensor communications. The emergency monitoring sensing network platform 120 may be configured as a communication network and a gateway to perform functions such as network management, protocol management, instruction management, and data parsing.

In some embodiments, the emergency monitoring sensing network platform may include a plurality of sensing network sub-platforms, with each sensing network sub-platform corresponding to a management of sensor communications in a protection region.

In some embodiments, the emergency monitoring sensing network platform 120 may interact with the emergency monitoring perception and control platform 110 and the emergency monitoring and management platform 130 for data exchange. For example, the emergency monitoring sensing network platform 120 may receive the emergency monitoring data sent by the emergency monitoring perception and control platform 110 and send the emergency monitoring data to the emergency monitoring and management platform 130 for processing. As another example, the emergency monitoring sensing network platform 120 may receive an emergency control parameter sent by the emergency monitoring and management platform 130 and send the emergency control parameter to the emergency monitoring perception and control platform 110 for execution.

The emergency monitoring and management platform 130 refers to a comprehensive platform that coordinates and organizes connections and collaborations between various functional platforms, aggregates all the information of the IoT, and provides perception management and control management functions.

In some embodiments, the emergency monitoring and management platform 130 may include a processor, a server, or a server cluster, etc.

The processor may be configured to process data and/or information obtained from other devices/components or parts. The processor may execute program instructions based on the data, information, and/or processing results to implement one or more of the functions described in the embodiments of the present disclosure. In some embodiments, the processor may include one or more sub-processing devices (e.g., a single-core processing device or a multi-core processing device). By way of example only, the processor may include, but is not limited to, a central processing unit (CPU), a controller, a microprocessor, or the like, or any combination thereof. In some embodiments, the processor may include a plurality of modules, and different modules may be configured to execute separate program instructions, respectively.

In some embodiments, the emergency monitoring and management platform 130 may include a data center, the data center being configured with a storage device. The data center may store all the data of the system 100 for smart city firefighting and automatic extinguishment based on an IoT large model, for example, historical fire-related data, the emergency monitoring data, regional characteristic data, or the like.

In some embodiments, the emergency monitoring and management platform 130 may include a plurality of emergency management sub-platforms. Each of the plurality of emergency management sub-platforms may be communicatively connected to one of a plurality of sensor network sub-platforms.

In some embodiments, the emergency monitoring and management platform 130 may be configured to perform the method for smart city firefighting and automatic extinguishment based on an IoT large model as described in any of the embodiments of the present disclosure.

The emergency monitoring service platform 140 refers to a platform that provides emergency monitoring services to a user. The emergency monitoring service platform 140 may be configured as a server, a gateway, a router, etc.

In some embodiments, the emergency monitoring service platform 140 may interact with the emergency monitoring and management platform 130 and the emergency monitoring user platform 150 for data or information exchange. For example, the emergency monitoring service platform 140 may receive fire-related information sent by the emergency monitoring user platform 150 and send the fire-related information to the emergency monitoring and management platform 130 for processing. As another example, the emergency monitoring service platform 140 may receive emergency monitoring information sent by the emergency monitoring and management platform 130 and send the emergency monitoring information to the emergency monitoring user platform 150.

The fire-related information may be any information related to the fire, such as a fire location, a failure condition of the firefighting device, or the like.

The emergency monitoring information may be any information related to fire monitoring, such as a fire warning, a fire location, escape route data, etc.

The emergency monitoring user platform 150 refers to a platform that interacts with the user. The emergency monitoring user platform 150 may be configured as a terminal device. For example, the terminal device is a smartphone, a tablet PC, a smartwatch, or the like.

In some embodiments, the user may view the emergency monitoring information (e.g., a fire warning, a resource state, etc.) via the emergency monitoring user platform 150. In some embodiments, the user may upload the fire-related information (e.g., emergency events such as the fire location, equipment failure, etc.) on the emergency monitoring user platform 150.

It should be noted that the foregoing description of the system 100 for smart city firefighting and automatic extinguishment based on an IoT large model is for the purpose of exemplification and illustration only and does not limit the scope of application of the present disclosure.

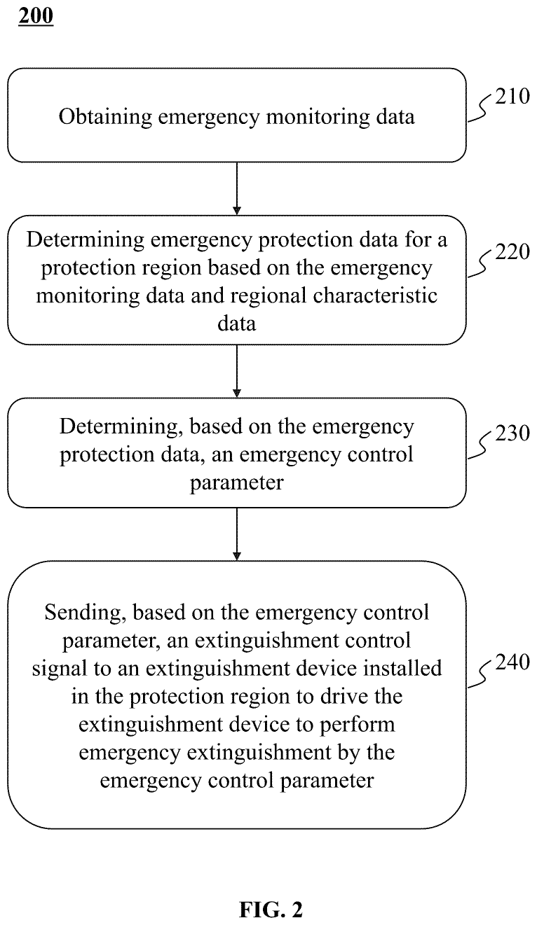

FIG. 2 is an exemplary flowchart illustrating a method for smart city firefighting and automatic extinguishment based on an IoT large model according to some embodiments of the present disclosure. In some embodiments, a process 200 may be performed by the emergency monitoring and management platform 130 or a processor. More descriptions regarding the platform may be found in FIG. 1 and related descriptions thereof. As shown in FIG. 2, the process 200 includes the following operations.

In 210, emergency monitoring data may be obtained.

The emergency monitoring data refers to relevant data that reflects whether or not a fire occurs in a monitoring object, for example, whether there is a fire on a building external wall, whether there is an abnormal increase in temperature, or the like.

The monitoring object refers to a predefined building component that requires fire monitoring, for example, a building wall.

In some embodiments, the emergency monitoring data may include image data and temperature data of the monitoring object. For example, the image data may include image data of the building wall, and the temperature data may include wall temperature distribution data.

In some embodiments, the processor may obtain, via the emergency monitoring sensing network platform, the emergency monitoring data monitored by the emergency monitoring perception and control platform (e.g., a monitoring device), such as image data obtained by an image sensor and temperature data obtained by an environmental sensor. The processor may periodically obtain the emergency monitoring data in a first cycle. More descriptions regarding the first cycle may be found in operation 220 and related descriptions thereof.

In 220, emergency protection data for a protection region may be determined based on the emergency monitoring data and regional characteristic data.

The regional characteristic data refers to data reflecting a characteristic of a building in the protection region.

The protection region refers to a predefined region that requires fire protection, for example, a single building, or a plurality of buildings in a region. The protection region may include a plurality of monitoring objects (e.g., a plurality of walls of the single building).

In some embodiments, the regional characteristic data may include building structure characteristic data and wall characteristic data. The building structure characteristic data refers to data that characterizes a building distribution. For example, the building structure characteristic data includes a layout, a design, a location, and a density, of a building. The wall characteristic data refers to data that characterize the monitoring object. For example, the wall characteristic data includes a wall thickness, a wall area, and a material type, of a building.

In some embodiments, a government or an enterprise may collect the regional characteristic data and store the regional characteristic data to a data center of the emergency monitoring and management platform, and the processor may access the regional characteristic data through the data center.

The emergency protection data refers to data reflecting a fire protection situation of a building in the protection region. In some embodiments, the emergency protection data may include a protection characteristic and a protection level.

The protection level refers to a degree of fire protection required. The higher the protection level, the greater the degree of the fire protection required, i.e., it is needed to test a fire-monitored building at a higher frequency.

The protection characteristic refers to a fire-starting point that requires fire protection (e.g., a high-risk fire-starting point), for example, a location in the wall where there is a potential fire-starting point, a building external wall where a wall fire protection capability is below a threshold. The protection characteristic may also include a count of fire-starting points.

In some embodiments, the processor may determine the protection level based on the emergency monitoring data and the regional characteristic data in a plurality of ways.

In some embodiments, the processor may determine the protection level based on the wall characteristic data and a wall location by matching in a first vector database.

The first vector database refers to a predetermined database including a plurality of reference protection characteristic vectors and corresponding protection labels. The processor may construct the reference protection characteristic vectors based on the wall characteristic data and the wall locations in a large amount of historical data or experimental data from the data center, and determine reference wall fire protection capabilities corresponding to the reference protection characteristic vectors as the protection labels.

The wall location refers to a location of the wall in the building.

The wall fire protection capability refers to a capability of a wall to resist fire. The reference wall fire protection capability may be determined based on an external wall fire spread speed in the historical data, and a damage extent to the wall before and after the fire. For example, the higher the external wall fire spread speed and the damage extent to the wall, the lower the reference wall fire protection capability. The damage extent to the wall may be measured by cosmetic damage and structural damage.

In some embodiments, the processor may construct a protection characteristic vector based on the wall characteristic data and the wall location; determine the wall fire protection capability by matching based on the protection characteristic vector in the first vector database; and determine the protection level based on the wall fire protection capability. The protection level is negatively correlated to the wall fire protection capability. The processor may look up in the first vector database for a protection label corresponding to a reference protection characteristic vector that has the highest similarity (e.g., the smallest vector distance) to the protection characteristic vector and determine the protection label as the wall fire protection capability.

In some embodiments, the processor may determine the protection characteristic in a plurality of ways based on the emergency monitoring data and the regional characteristic data.

In some embodiments, the processor may determine a high-risk fire-starting point based on the image data and the temperature data, and add the high-risk fire-starting point to the protection characteristic to determine the protection characteristic.

In some embodiments, the processor may obtain a wall appearance characteristic based on the image data, obtain a temperature distribution characteristic based on the temperature data, determine the high-risk fire-starting point for the monitoring object based on the wall appearance characteristic and the temperature distribution feature, and add the high-risk fire-starting point to the protection characteristic to determine the protection characteristic. The processor may repeat the above operations to continually determine a latest protection characteristic.

The wall appearance characteristic refers to data that characterize an appearance of the wall. The wall appearance characteristic may include a wear point on the external wall and a corresponding wear degree. In some embodiments, the processor may obtain the wall appearance characteristic based on the image data by an image recognition algorithm. For example, the image recognition algorithm may include an edge detection algorithm, a trained machine learning model, or the like.

The temperature distribution characteristic refers to data that characterizes a temperature distribution of the wall. The temperature distribution characteristic may include a collection of temperatures at a plurality of locations on the monitoring object.

The high-risk fire-starting point refers to a point location that is prone to fire-starting. In some embodiments, the processor may determine a location of the external wall that has a wear degree higher than a wear threshold and a temperature higher than a high-risk temperature threshold as the high-risk fire-starting point. In some embodiments, the processor may also perform a weighted sum of the wear degree of the external wall and the temperature, and determine a location where a weighted sum is higher than a weighted threshold as the high-risk fire-starting point. The wear threshold, the high-risk temperature threshold, and the weighted threshold may be empirically or artificially preset.

In some embodiments, the processor may obtain an operational flame characteristic based on the first cycle and the emergency monitoring data; determine an estimated fire risk based on the operational flame characteristic and the emergency monitoring data; and determine the emergency protection data based on the estimated fire risk.

The operational flame characteristic refers to a characteristic associated with flames. In some embodiments, the operational flame characteristic includes a flame location, a flame type, a flame size, a flame duration, or the like. The processor may recognize a flame in the image data during the first cycle by the image recognition algorithm to obtain the operational flame characteristic.

The first cycle refers to a predetermined period for determining the emergency protection data. At each interval of the first cycle, the processor may obtain the emergency monitoring data in the first cycle to determine the emergency protection data.

In some embodiments, the processor may determine a length of the first cycle based on the emergency protection data and/or the operational flame characteristic.

The length of the first cycle correlates to the wall fire protection capability of the building within the protection region. The lower the wall fire protection capability, indicating that the building needs to be monitored at a higher frequency, the shorter the length of the first cycle.

The length of the first cycle also correlates with the operational flame characteristic in the protection region. The more frequent the occurrence of flames and the larger the flame size, the shorter the length of the first cycle.

In some embodiments of the present disclosure, the emergency protection data and/or the operational flame characteristic allow for a targeted determination of the length of the first cycle based on a fire protection situation in the protection region and the occurrence of flames to determine an appropriate monitoring frequency.

The estimated fire risk refers to a result of a quantitative assessment of the likelihood of a fire occurring in the protection region and a potential harmful degree of the fire.

In some embodiments, the processor may determine the estimated fire risk based on the operational flame characteristic and the emergency monitoring data through a risk estimation model.

In some embodiments, the risk estimation model is a machine learning model. For example, the risk estimation model is a neural network model, a recurrent neural networks (RNN) model, etc.

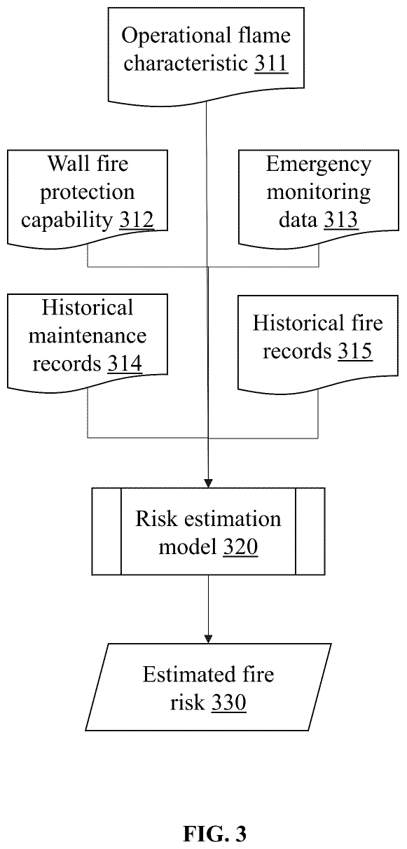

FIG. 3 is an exemplary schematic diagram illustrating a risk estimation model according to some embodiments of the present disclosure. In some embodiments, as illustrated in FIG. 3, inputs to a risk estimation model 320 may include an operational flame characteristic 311 during a previous first cycle A, a wall fire protection capability 312, emergency monitoring data 313, historical maintenance records 314, and historical fire records 315, and an output of the risk estimation model 320 may include an estimated fire risk 330.

More descriptions regarding the operational flame characteristic, the wall fire protection capability, and the emergency monitoring data may be found in FIG. 2 and related descriptions thereof.

The historical maintenance records refer to records of maintenance and inspection records of an extinguishment device or a flame device in historical data. The flame device refers to a device that produces the flame, such as a gas stove. The flame device is installed in the protection region. The historical fire records refer to fire records (e.g., a fire location, a fire size, etc.) in the historical data and records of historical emergency control parameters of the extinguishment device during a fire event. The historical maintenance records and historical fire records may be obtained from the historical data stored in the data center. The estimated fire risk includes the fire location, the fire size, and a corresponding occurrence probability at each time point within a first cycle B next to the first cycle A. The first cycle A and the first cycle B are two adjacent first cycles.

In some embodiments, the risk estimation model may be obtained by training based on training data. In some embodiments, the processor may obtain a plurality of first training samples with first labels to constitute a first training sample set, and perform a plurality of iterations based on the first training sample set.

The first training samples may include a sample operational flame characteristic, a sample wall fire protection capability, sample emergency monitoring data, sample historical maintenance records, and sample historical fire records in a previous first cycle of the historical data. The first labels may be the fire location, the fire size, and corresponding incident details recorded at each point in a next first cycle corresponding to the first training samples. The processor may label an open flame incident in the first training samples as 1, and no incident as 0.

In some embodiments, the processor may input the first training sample set into an initial risk estimation model to perform a plurality of rounds of iterations. Each round of iteration includes selecting one or more first training samples from the first training sample set, inputting the one or more first training samples into the initial risk estimation model, obtaining one or more model estimation outputs corresponding to the one or more first training samples; substituting the one or more model estimation outputs and the first labels of the one or more first training samples into a formula of a predefined loss function to calculate a value of the loss function; inversely updating model parameters of the initial risk estimation model based on the value of the loss function. When an iteration end condition is satisfied, the iteration is ended to obtain the trained estimation model. The iteration end condition may be that the loss function converges, the count of rounds of iterations reaches a threshold, etc.

In some embodiments, the training of the risk estimation model may include an initial training phase and a reinforcement training phase, wherein the initial training phase may be trained using a large amount of sample data that includes other protection regions, and the reinforcement training phase may be trained using sample data of the present protection region or sample data from neighboring protection regions.

In some embodiments of the present disclosure, determining the estimated fire risk by the risk estimation model may utilize the self-learning capability of the machine learning model to find a rule from a large amount of historical data, which improves the accuracy and efficiency of determining the estimated fire risk.

In some embodiments, the processor may determine a device aging degree based on the emergency monitoring data; and determine the estimated fire risk based on the device aging degree, the operational flame characteristic, and the emergency monitoring data.

The device aging degree refers to a parameter reflecting a degradation state of device performance. In some embodiments, the device aging degree includes an aging degree of the extinguishment device and an aging degree of an electrical wiring. The processor may determine the aging degree of the extinguishment device based on a usage time of the extinguishment device, and the aging degree of the electrical wiring based on a usage time of the electrical wiring. The longer the usage time, the higher the aging degree. The usage time may be obtained from the data center.

In some embodiments, the processor may obtain an appearance characteristic of the device based on the emergency monitoring data. The appearance characteristic includes a defect type, a defect area, and a density. The defect type may include rust, cracks, coating peeling, etc.

In some embodiments, the processor may calculate to obtain a total initial score based on the appearance characteristic; and multiply the total initial score by a density correction factor to obtain a composite score. For example, the processor may set a type weight based on a degree to which different defect types affect the function of the device; compute to obtain an area proportion of an individual defect and a total defect density of all defects based on the appearance characteristic; multiply an area proportion of each defect type by the type weight to obtain a defect score for each defect type, and sum defect scores of all defect types to obtain the total initial score. The density correction factor may be determined based on the total defect density. The processor may directly determine the composite score as the device aging degree. A higher composite score indicates a higher device aging degree.

In some embodiments, the processor may input the device aging degree into the risk estimation model to determine the estimated fire risk. The first training samples of the risk estimation model may also include a sample device aging degree.

In some embodiments of the present disclosure, the fire risk can be predicted more accurately by determining the device aging degree.

In some embodiments, the processor may determine the protection characteristic based on the estimated fire risk.

For example, the processor may determine walls around (e.g., within a radius Y) a location where a fire occurrence probability in the estimated fire risk is greater than a preset fire threshold and wear locations on the walls, as walls and fire-starting points to be guarded in the protection characteristic. Y may be positively correlated to the occurrence size in the estimated fire risk.

In some embodiments of the present disclosure, determining the emergency protection data by predicting the fire risk allows for more accurate and efficient fire protection and emergency response.

In 230, an emergency control parameter may be determined based on the emergency protection data.

The emergency control parameter refers to a parameter associated with emergency extinguishment. In some embodiments, the emergency control parameter includes a protection activation condition, an extinguishment target, and a protection-extinguishment parameter.

The protection activation condition refers to a predefined activation condition for the extinguishment device. For example, the protection activation condition may include a condition threshold for determining whether the extinguishment device is activated or not, e.g., a temperature threshold, a humidity threshold, a smoke concentration threshold, etc. The processor may preset the protection activation condition based on experience or by humans.

In some embodiments, the processor may determine whether or not the extinguishment device needs to be activated based on the emergency protection data to perform extinguishment. The determination of whether the extinguishment device is activated may require only one conditional threshold to be met, or may require a plurality of conditional thresholds to be met simultaneously. For example, the extinguishment device may be determined to be activated when the temperature is above a temperature threshold. As another example, the extinguishment device may only be determined to be activated when the temperature is above the temperature threshold, the humidity is below a humidity threshold, and the smoke concentration is above a smoke concentration threshold.

In some embodiments, the processor may determine the conditional threshold in the protection activation condition based on an associated range corresponding to the protection-extinguishment parameter. For example, the more walls in the associated range corresponding to the protection-extinguishment parameter with the protection level higher than a predetermined threshold or the greater the wall area, the processor may set the temperature threshold and the smoke concentration threshold to be lower and set the humidity threshold to be higher. The associated range refers to a range within an X-meter radius of the extinguishment device. A value of X may be preset based on a type of the fire extinguisher.

The extinguishment target refers to a target where a fire has occurred and extinguishment needs to be performed. For example, the extinguishment target may be a building having an external wall.

In some embodiments, the processor may determine the extinguishment target in a plurality of ways based on the protection level and/or the protection characteristic of the monitoring object within the associated range.

In some embodiments, the processor may determine a building or a wall with the highest protection level within the associated range and/or with the highest count of the fire-starting points to be protected in the protection characteristic as the extinguishment target. The processor may also perform a weighted sum of the protection level of the building or the wall within the association range with the count of the fire-starting points in the protection characteristic, and determine the building or the wall with the largest weighted sum as the extinguishment target.

In some embodiments, the processor may divide the associated range of the extinguishment device into a plurality of associated subranges; calculate an average of the protection levels of all the walls within the associated subranges; and calculate an average of the count of the fire-starting points in the protection characteristics of all the walls within the associated subranges. The processor may select the associated subrange with the largest average value as the extinguishment target for the fire extinguisher. The processor may also perform a weight sum of the average value of the protection levels with the average value of the count of the fire-starting points, and determine the associated subrange with the largest weighted sum as the extinguishment target. For example, the processor may divide the associated range into the plurality of associated subranges, and one associated subrange may be a sector region of 15 degrees, 30 degrees, 45 degrees, 60 degrees, or the like.

The protection-extinguishment parameter refers to a parameter that is used to perform emergency extinguishment. In some embodiments, the protection-extinguishment parameter includes an activation time regulation value, an extinguishment angle parameter, and an extinguishment intensity parameter.

In some embodiments, the activation time regulation value includes an activation duration and an activation interval. The processor may control the activation duration, the activation interval, or the like, when the extinguishment device performs extinguishment based on the activation time regulation value.

In some embodiments, the extinguishment angle parameter includes a preset facing angle of the fire extinguisher. The processor may control a facing angle of the fire extinguisher based on the extinguishment angle parameter.

In some embodiments, the extinguishment intensity parameter includes an extinguishment pressure, a preset coverage area, and a preset spray flow rate. The processor may control the extinguishment pressure, a coverage area, and a spray flow rate of the extinguishment device based on the extinguishment intensity parameter.

In some embodiments, the processor may determine the extinguishment intensity parameter based on the protection characteristics and the protection levels of different walls.

In some embodiments, the processor may determine the activation duration and the activation interval based on the protection level of the associated subrange or the count of the fire-starting points. The larger the average value of the protection level of the building or the wall in the associated subrange, the larger the average value of the count of the fire-starting points, or the larger the weighted sum of the average value of the protection level and the average value of the count of fire-starting points, and the longer the duration and the shorter the activation interval the processor may determine.

In some embodiments, the processor may determine the preset coverage area and the preset spray flow rate based on the protection level or the count of the fire-starting points for the associated subrange. The larger the average value of the protection level of the building or the wall in the associated subrange, the larger the average value of the count of the fire-starting points, or the larger the weighted sum of the average value of the protection level and the average value of the count of the fire-starting points, the larger the preset coverage area and the greater the preset spray flow rate the processor may determine.

In some embodiments, the processor may obtain a plurality of candidate control parameters; determine a fire protection effect corresponding to the plurality of candidate parameters based on the plurality of candidate control parameters and the estimated fire risk; and determine the emergency control parameter based on the fire protection effect.

The candidate control parameter refers to a parameter that is alternatives to the emergency control parameter. In some embodiments, the candidate control parameters include a candidate protection activation condition and a candidate protection-extinguishment parameter. The processor may randomly set the candidate control parameter, or screen out a case of successful fire control (e.g., fire not spreading, low property damage, etc.) from historical fire data and extract the emergency control parameter corresponding to the case as the candidate control parameter.

In some embodiments, the processor may determine the plurality of candidate control parameters based on the historical fire data. For example, the processor may mine a strong association rule between the emergency control parameter and the fire protection effect in the historical fire data based on an association rule mining algorithm (e.g., an Apriori algorithm) to obtain the candidate control parameter.

For example, if the strong association rule is determined to be {a low startup temperature threshold, a high spray flow rate}-a high extinguishment protection effect, the processor may pick from a range of the low startup temperature threshold and a range of the high spray flow rate to generate one or more candidate control parameters.

In some embodiments, for each candidate control parameter, the processor may determine the fire protection effect corresponding to the candidate control parameter based on the candidate control parameter and the estimated fire risk through an effect determination model.

In some embodiments, the effect determination model is a machine learning model. For example, the effect determination model is a neural network model, a recurrent neural network (RNN) model, etc.

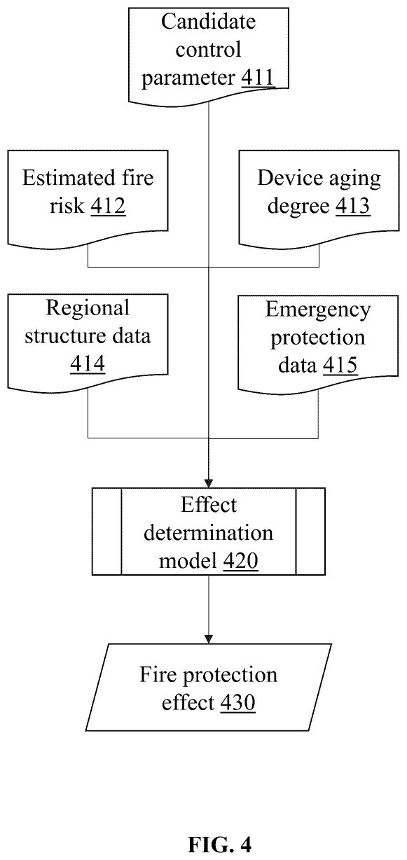

FIG. 4 is an exemplary schematic diagram illustrating an effect determination model according to some embodiments of the present disclosure. In some embodiments, as shown in FIG. 4, inputs to an effect determination model 420 may include a candidate control parameter 411, an estimated fire risk 412, a device aging degree 413, regional structure data 414, emergency protection data 415, and an output to the effect determination model 420 may include a fire protection effect 430 corresponding to the candidate control parameter 411.

More descriptions regarding the candidate control parameter, the estimated fire risk, the device aging degree, and the emergency protection data may be found in FIG. 2 and related descriptions thereof.

The regional structure data may include a building floor plan and fire protection facility distribution data within the protection region. The regional structure data may be retrieved directly from the data center or obtained by drone photography.

In some embodiments, the effect determination model may be obtained by training based on training data. In some embodiments, the processor may obtain a plurality of second training samples with second labels to constitute a second training sample set, and perform a plurality of round of iterations based on the second training sample set. A training process of the effect determination model is similar to the training process of the risk estimation model.

The second training samples may include a sample candidate control parameter, a sample estimated fire risk, a sample device aging degree, a sample regional structure data, and a sample emergency protection data obtained based on the historical data. The second label may be an actual evaluated fire protection effect corresponding to the second training sample. For example, the processor may evaluate the fire protection effect by evaluating a fire duration, a fire spread range, and a caused property damage. The smaller the fire duration, the fire spread range, and the caused property damage, the better the fire protection effect.

In some the embodiments of the present disclosure, determining the fire protection effect by the effect determination model may utilize the self-learning capability of the machine learning model to find a rule from a large amount of historical data, which improves the accuracy and efficiency of determining the fire protection effect.

In some embodiments, the processor may select the candidate control parameter with the best fire protection effect as the determined emergency control parameter.

In some embodiments, the emergency control parameter further includes a monitoring and regulating parameter, and the processor may determine the monitoring and regulating parameter based on the emergency protection data and an acquired bandwidth quality; and send a monitoring control signal to the monitoring device installed in the protection region based on the monitoring and regulating parameter to control the monitoring device to adjust a monitoring frequency and a monitoring angle by the monitoring and regulating parameter.

The monitoring and regulating parameter refers to a relevant parameter for controlling the monitoring device. More descriptions regarding the monitoring device may be found in FIG. 1 and related descriptions thereof. In some embodiments, the monitoring and regulating parameter includes the monitoring frequency and the monitoring angle of the monitoring device.

For example, when a density of the high-risk fire-starting points within a monitoring range is high, the processor may appropriately increase the monitoring frequency of the monitoring device to ensure a monitoring effect of a high-risk region. As another example, the processor may obtain an aggregated location of the high-risk fire-starting points and adjust the monitoring angles of a plurality of monitoring devices so that an overlapping coverage rate of the monitoring ranges of the plurality of monitoring devices for the aggregated location exceeds a threshold value to ensure the monitoring effect of the aggregated location.

The acquired bandwidth quality refers to a performance indicator that reflects data transmission capability. The higher the monitoring frequency, the more data is acquired, and if the acquired bandwidth quality is not sufficient, data congestion may be caused. The acquired bandwidth quality is inherent to the performance of the monitoring device, and may be obtained directly through the monitoring device.

In some embodiments, the processor may determine the monitoring and regulating parameter based on the density of the fire-starting points and the acquired bandwidth quality by querying a bandwidth quality table. The bandwidth quality table may include the density of different fire-starting points, the acquired bandwidth quality, and the corresponding monitoring frequency.

In some embodiments of the present disclosure, determining the monitoring and regulating parameter through the emergency protection data and the acquired bandwidth quality to control the monitoring frequency and the monitoring angle of the monitoring device can realize optimal allocation of resources of the monitoring device so as to safeguard the monitoring effect while improving system efficiency.

In 240, an extinguishment control signal may be sent to the extinguishment device installed in the protection region based on the emergency control parameter to drive the extinguishment device to perform emergency extinguishment by the emergency control parameter.

In some embodiments, the processor may send the extinguishment control signal to the extinguishment device based on the emergency control parameter through the emergency monitoring sensing network platform.

In some embodiments, the processor may control rotation of a spray head of the extinguishment device to orient toward the extinguishment target; and in response to satisfying the protection activation condition, activate the extinguishment device to perform extinguishment based on the protection-extinguishment parameter with the preset coverage area and the preset spray flow rate. The processor may control the extinguishment device to turn on or turn off based on the activation time regulation value. The processor may control the spray head of the extinguishment device to orient according to the extinguishment angle parameter so that the spray head sprays at the preset facing angle.

In some embodiments, the processor may determine false trigger data based on a second cycle, the emergency monitoring data, and the emergency control parameter; determine a correction parameter based on the false trigger data; update the emergency control parameter based on the correction parameter to obtain an updated emergency control parameter; and issue the updated emergency control parameter to the extinguishment device installed in the protection region.

The second cycle is a preset period for determining the false trigger data. At each interval of the second cycle, the processor may obtain the emergency monitoring data and the emergency control parameter in the second cycle to determine the false trigger data accordingly. A length of the second cycle is less than the length of the first cycle.

The false trigger data is data associated with the false trigger. In some embodiments of the present disclosure, the false trigger data includes a count of false triggers in the previous second cycle, environmental data at the time of each false trigger, and a corresponding activation condition. The processor may extract the false trigger data based on the emergency monitoring data or the emergency control parameter at each false trigger during the second cycle. The determination of whether a false trigger occurred may be confirmed by reports from personnel. For example, a resident may report a false trigger, or staff may identify one when reviewing historical records.

The correction parameter refers to data that corrects the emergency control parameter (e.g., the protection activation condition). In some embodiments, the correction parameter may include a correction term and an adjustment amount. For example, the correction term is the temperature threshold, and the adjustment amount is a degree to modify a current temperature threshold, a degree to lower the temperature threshold, or the like.

In some embodiments, the processor may determine the correction parameter based on the false trigger data in a plurality of ways.

In some embodiments, the processor may adjust the protection activation condition based on environmental data and corresponding activation conditions at times of a plurality of false triggers. For example, when a count of false triggers due to satisfying the temperature threshold reaches a false trigger threshold, the processor may increase the temperature threshold in the protection activation condition.

In some embodiments, the processor may determine the adjustment amount in the protection activation condition based on the wall fire protection capability of a plurality of fire-monitored buildings surrounding the extinguishment device. For example, when the plurality of fire-monitoring buildings surrounding the extinguishment device have a weak wall fire protection capability, the processor may reduce the adjustment amount in the correction parameter to ensure that the extinguishment device is sensitive to try to avoid fire spreading.

In some embodiments of the present disclosure, by determining the false trigger data and the correction parameter for updating the emergency control parameter, damage due to the false trigger may be reduced, and control of the extinguishment device may be optimized to improve the efficiency and accuracy of disaster response.

In some embodiments, the processor may determine the operational flame characteristic during false triggering based on the emergency monitoring data and the false trigger data; determine operational impact data based on the operational flame characteristic during false triggering; and determine the correction parameter based on the operational impact data.

The determination of the operational flame characteristic during false triggering may be found in operation 220, with a difference that the processor recognizes the operational flame characteristic in the false trigger data.

The operational impact data refers to data reflecting a danger level or an interruption risk of an operational flame. The danger level of the operational flame may be preset. The interruption risk refers to a potential loss that may result from an interruption of the operational flame.

In some embodiments, the processor may determine the operational impact data based on the operational flame characteristic during the false triggering and the emergency monitoring data during the false triggering by matching in a second vector database.

The second vector database refers to a predetermined database including a plurality of reference operational characteristic vectors and corresponding operational labels. The processor may construct the reference operational characteristic vectors based on the operational flame characteristic during the false triggering and the emergency monitoring data during the false triggering in a large amount of historical data or experimental data from the data center, and determine the reference operational impact data corresponding to the reference operational characteristic vectors as the operational labels. The reference operational impact data may be obtained by evaluating a size, a type, and a duration of a corresponding flame, and an economic loss caused by a flame interruption.

In some embodiments, the processor may construct an operational characteristic vector based on the operational flame characteristic during the false triggering and the emergency monitoring data during the false triggering; and determine the operational impact data by matching based on the operational characteristic vector in the second vector database. The processor may look up in the second vector database for an operational label corresponding to a reference operational feature vector that has the highest similarity (e.g., the smallest vector distance) to the operational characteristic vector, and determine the operational label as the operational impact data.

In some embodiments, the processor may determine the adjustment amount in the correction parameter based on the danger level and the interruption risk of the flame operation in the operational impact data. The lower the danger level and the interruption risk of the operational flame, the greater the adjustment amount.

In some embodiments of the present disclosure, by determining the operational impact data, the adjustment amount of the correction parameter may be determined more accurately, avoiding the risk associated with interruption of the operational flame due to the false triggering.

In some embodiments, the processor may determine the correction parameter based on the estimated fire risk in a next first cycle and the false trigger data in a previous second cycle. The next first cycle refers to a next first cycle B of the first cycle A. The previous second cycle refers to a previous second cycle C of a current second cycle D. The second cycle C and the second cycle D are two adjacent second cycles.

For the extinguishment device, if a proportion of buildings/walls within the association range with a low fire risk level is greater than a risk threshold, and the count of false triggers of the extinguishment device within the previous second cycle is greater than the false trigger threshold, the processor increases a corresponding condition threshold of the protection activation condition. The risk threshold may be positively correlated to a count of buildings or walls within the association range of the extinguishment device.

In some embodiments of the present disclosure, determining the correction parameter in the manner described above may improve the adaptability of the system to complex environments, and reduce the miscalculations due to differences in protection regions.

In some embodiments of the present disclosure, through the above method for smart city firefighting and automatic extinguishment based on an IoT large model, the protection level and the protection characteristic may be dynamically generated based on the emergency monitoring data of different fire-monitored buildings to automatically control the extinguishment device to be turned on and perform emergency extinguishment according to the emergency control parameter, reducing a fire spreading risk, improving a disaster response speed and the resource utilization efficiency, and thus improving the extinguishment efficiency and reduce a disaster loss.

It should be noted that the foregoing descriptions of process 200 are for illustrative purposes only and do not limit the scope of application of the present disclosure. For those skilled in the art, various corrections and changes can be made to process 200 under the guidance of the present disclosure. However, these corrections and changes remain within the scope of the present disclosure.

One or more embodiments of the present disclosure provide an IoT large model system for smart city firefighting and automatic extinguishment. The system includes an emergency monitoring and management platform and an emergency monitoring sensing network platform. The emergency monitoring and management platform includes at least one processor and at least one memory; the at least one memory stores computer instructions; the at least one processor executes at least a portion of the computer instructions to perform the method for smart city firefighting and automatic extinguishment based on an IoT large model as described in any of the above embodiments. The IoT large model system for smart city firefighting and automatic extinguishment may be part of the system for smart city firefighting and automatic extinguishment based on an IoT large model.

One or more embodiments of the present disclosure provide a non-transitory computer readable storage medium. The computer-readable storage medium stores computer instructions, and when a processor executes the computer instructions in the storage medium, the processor implements the method for smart city firefighting and automatic extinguishment based on an IoT large model as described in any of the embodiments of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment,” “one embodiment,” or “an alternative embodiment” in various portions of the present disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A system for smart city firefighting and automatic extinguishment based on an Internet of Things (IoT) large model, comprising an emergency monitoring and management platform configured to:
obtain emergency monitoring data;
determine emergency protection data for a protection region based on the emergency monitoring data and regional characteristic data;
determine, based on the emergency protection data, an emergency control parameter, the emergency control parameter including a protection activation condition, an extinguishment target, and a protection-extinguishment parameter;
send, based on the emergency control parameter, an extinguishment control signal to an extinguishment device installed in the protection region through an emergency monitoring sensing network platform to drive the extinguishment device to perform emergency extinguishment by the emergency control parameter, including:
controlling rotation of a spray head of the extinguishment device to orient toward the extinguishment target; and
in response to satisfying the protection activation condition, activating the extinguishment device to perform extinguishment based on the protection-extinguishment parameter with a preset coverage area and a preset spray flow rate.

2. The system according to claim 1, wherein the emergency control parameter includes a monitoring and regulating parameter; and the emergency monitoring and management platform is further configured to:
determine the monitoring and regulating parameter based on the emergency protection data and an acquired bandwidth quality; and
send, based on the monitoring and regulating parameter, a monitoring control signal to a monitoring device installed in the protection region to control the monitoring device to adjust a monitoring frequency and a monitoring angle by the monitoring and regulating parameter.

3. The system according to claim 1, wherein the emergency monitoring and management platform is further configured to:
obtain an operational flame characteristic based on a first cycle and the emergency monitoring data;
determine an estimated fire risk based on the operational flame characteristic and the emergency monitoring data; and
determine the emergency protection data based on the estimated fire risk.

4. The system according to claim 3, wherein the emergency monitoring and management platform is further configured to:
determine a length of the first cycle based on the emergency protection data and the operational flame characteristic.

5. The system according to claim 3, wherein the emergency monitoring and management platform is further configured to:
determine a device aging degree based on the emergency monitoring data; and
determine the estimated fire risk based on the device aging degree, the operational flame characteristic, and the emergency monitoring data.

6. The system according to claim 3, wherein the emergency monitoring and management platform is further configured to:
obtain a plurality of candidate control parameters;
determine, based on the plurality of candidate control parameters and the estimated fire risk, a fire protection effect corresponding to the plurality of candidate parameters; and
determine the emergency control parameter based on the fire protection effect.

7. The system according to claim 3, wherein the emergency monitoring and management platform is further configured to:
determine the plurality of candidate control parameters based on historical fire data.

8. The system according to claim 1, wherein the emergency monitoring and management platform is further configured to:
determine false trigger data based on a second cycle, the emergency monitoring data, and the emergency control parameter;
determine, based on the false trigger data, a correction parameter;
update the emergency control parameter based on the correction parameter to obtain an updated emergency control parameter; and
issue the updated emergency control parameter to the extinguishment device installed in the protection region.

9. The system according to claim 8, wherein the emergency monitoring and management platform is further configured to:
determine an operational flame characteristic during false triggering based on the emergency monitoring data and the false trigger data;
determine operational impact data based on the operational flame characteristic during false triggering; and
determine the correction parameter based on the operational impact data.

10. The system according to claim 9, wherein the emergency monitoring and management platform is further configured to:
determine the correction parameter based on an estimated fire risk in a next first cycle and the false trigger data in a previous second cycle.

11. A method for smart city firefighting and automatic extinguishment based on an Internet of Things (IoT) large model, comprising:
obtaining emergency monitoring data;
determining emergency protection data for a protection region based on the emergency monitoring data and regional characteristic data;
determining, based on the emergency protection data, an emergency control parameter, the emergency control parameter including a protection activation condition, an extinguishment target, and a protection-extinguishment parameter;
sending, based on the emergency control parameter, an extinguishment control signal to an extinguishment device installed in the protection region through an emergency monitoring sensing network platform to drive the extinguishment device to perform emergency extinguishment by the emergency control parameter, including:
controlling rotation of a spray head of the extinguishment device to orient toward the extinguishment target; and
in response to satisfying the protection activation condition, activating the extinguishment device to perform extinguishment based on the protection-extinguishment parameter with a preset coverage area and a preset spray flow rate.

12. The method according to claim 11, wherein the emergency control parameter further includes a monitoring and regulating parameter; and the method further comprises:
determining the monitoring and regulating parameter based on the emergency protection data and an acquired bandwidth quality; and
sending, based on the monitoring and regulating parameter, a monitoring control signal to a monitoring device installed in the protection region to control the monitoring device to adjust a monitoring frequency and a monitoring angle by the monitoring and regulating parameter.

13. The method according to claim 11, wherein the determining emergency protection data for a protection region based on the emergency monitoring data and regional characteristic data includes:
obtaining an operational flame characteristic based on a first cycle and the emergency monitoring data;
determining an estimated fire risk based on the operational flame characteristic and the emergency monitoring data; and
determining the emergency protection data based on the estimated fire risk.

14. The method according to claim 13, wherein the determining emergency protection data for a protection region based on the emergency monitoring data and regional characteristic data includes:
determining a length of the first cycle based on the emergency protection data and the operational flame characteristic.

15. The method according to claim 13, wherein determining the emergency control parameter based on the emergency protection data includes:
determining a device aging degree based on the emergency monitoring data; and
determining the estimated fire risk based on the device aging degree, the operational flame characteristic, and the emergency monitoring data.

16. The method according to claim 13, wherein determining the emergency control parameter based on the emergency protection data includes:
obtaining a plurality of candidate control parameters;
determining, based on the plurality of candidate control parameters and the estimated fire risk, a fire protection effect corresponding to the plurality of sets of candidate parameters; and
determining the emergency control parameter based on the fire protection effect.

17. The method according to claim 16, wherein determining the emergency control parameter based on the emergency protection data includes:
determining the plurality of candidate control parameters based on historical fire data.

18. The method according to claim 11, comprising:
determining false trigger data based on a second cycle, the emergency monitoring data, and the emergency control parameter;
determining, based on the false trigger data, a correction parameter;
updating the emergency control parameter based on the correction parameter to obtain an updated emergency control parameter; and
issuing the updated emergency control parameter to the extinguishment device installed in the protection region.

19. The method according to claim 18, wherein determining the correction parameter based on the false trigger data includes:
determining an operational flame characteristic during false triggering based on the emergency monitoring data and the false trigger data;
determining operational impact data based on the operational flame characteristic during false triggering; and
determining the correction parameter based on the operational impact data.

20. A non-transitory computer-readable storage medium storing computer instructions, wherein when the computer instructions are executed by a processor, the method according to claim 11 is implemented.
